(19) United States
(12) Patent Application Publication
(10) Pub. No.: US 2022/0020289 A1
(43) Pub. Date: Jan. 20, 2022

(54) METHOD AND APPARATUS FOR SPEECH LANGUAGE TRAINING

(71) Applicant: IQSonics LLC, Santa Monica, CA (US)

(72) Inventor: David Sonnenschein, Santa Monica, CA (US)

(73) Assignee: IQSonics LLC, Santa Monica, CA (US)

(21) Appl. No.: 17/375,782

(22) Filed: Jul. 14, 2021

Related U.S. Application Data
(60) Provisional application No. 63/052,120, filed on Jul. 15, 2020.

(51) Int. Cl. G09B 19/04; G09B 5/06

(52) U.S. Cl. CPC G09B 19/04; G09B 5/06

(57) ABSTRACT

The system is a web-based speech-language training game accessible on any internet connected device or other “assistive technology” (as defined by IDEA), comprised of a teaching method for a heterogeneous range of users who want to learn a second language, improve speaking skills, or users with speech-language delays/disorders, including ASD, Intellectual Disabilities, “at risk” and ELL (English Language Learners), trained by professionals, including special education teachers, speech-language pathologists, behavior interventionists and music therapists, and informal trainers, including parents and other caregivers. The system uses singing and musical instrument accompaniment to introduce a target word, followed by singing only, then followed by fill-in-the-blank target word with singing, followed by fill-in-the-blank target word by speaking, and finally answering a question by using the target word.

This patent application claims priority to U.S. Provisional Patent Application 63/052,120 filed on Jul. 15, 2020, which is incorporated by reference herein in its entirety.

### BACKGROUND OF THE SYSTEM

Children and other affected people with speech delays/disorders, either diagnosed or “at risk” must improve their speech-language skills to become kindergarten-ready and/or participate in typical schooling and socialization. Example sizes of this demographic of 2-7 year old children in the US who exhibit these delays/disorders, include over 1 million who are diagnosed with Autism Spectrum Disorder (ASD), and over 3.5 million who are “at risk”. For the purpose of this system description, children as young as 18 months are “at risk” if they face possible academic failure due to factors such as learning difficulties, low socioeconomic status, severe health problems, or language/communication difficulties. Affected people can also include including English Language Learners (ELL), also known as English Learners and Dual Language Learners.

There are many children with ASD severity levels 2 and 3 (DSM-5) It is estimated that those severity levels represent approximately 74% of the total population with ASD. Such children need speech and language training. The time allotted for teachers to train children may not be sufficient to produce maximum results. Parents could be a support for this training at home to help speech maintenance and generalization, but they are not prepared, and there is little integration and monitoring available for collaborative training with teachers and parents.

There have been some prior art attempts to help children and other affected people with language learning problems, including EIBI, Fast Forword, Gemiini, Teach Town: Basics, Amplio Speech, LENA, Presence Learning, and others. These approaches suffer a number of disadvantages, including high cost and time commitment, lack of engagement, excessive or insufficient parent engagement, lack of evidence of efficacy, lack of use of music to facilitate speech-language learning, inaccessibility for home study, and the like.

### SUMMARY

The system, in an embodiment comprises a teaching method for a heterogeneous range of children and other affected people with speech-language delays/disorders, including ASD, Intellectual Disabilities, “at risk” and ELL, who may be trained by professional trainers (e.g., special education teachers, speech-language pathologists, behavior interventionists, and music therapists) and informal trainers (e.g., parents and other caregivers), collectively referred to as “trainers”.

The system is a web-based speech-language training game accessible on any internet connected device or other “assistive technology” (as defined by the federal education law IDEA, Individual with Disabilities Education Act). The system may also be implemented as a stand-alone app, a progressive web app, a native, app, a cloud based app, and the like. The system is based in part on the clinically trialed music therapy known as Developmental Speech-Language Training through Music (DSLM) (Lim, 2010). Its effectiveness derives from the ability displayed by many children with speech delays/disorders to perceive and express musical patterns, and learning to sing songs before speaking (Kim et al., 2009; Kaplan et al., 2005; Moreno et al., 2011; Patel, 2011; Strait et al., 2011;). Principles of Growth Mindset (“Mistakes are a normal part of learning”, O'Rourke, E. et al 2014) and Game Based Learning (“Why games make us better and how they can change the world”, McGonigal, 2011) are employed to increase learning outcomes for children and trainers. Joint media engagement increases joint attention with support of the trainer alongside the child, actively and verbally participating in the game (Takeuchi et al., 2011). Song lyrics focus on situations, objects, and actions in everyday social activities, using concrete nouns, verbs, adjectives, and adverbs that are easily illustrated by corresponding photographic images. These developmentally appropriate target vocabulary words are derived, for example, from MacArthur-Bates (Fenson et al, 2007), and Dolch and Fry high frequency word lists (Farell et al, 2013).

The musical “scaffolding” of instrumental harmony and voice melody is faded step by step toward natural speech. Target words at the end of the phrase become omitted, so the user begins to verbally fill-in on their own, first singing, then speaking. The next stage prompts the user to speak the target word as an answer to a question accompanied by the on-screen photo. The final stage aims to generalize the user's speech of the target word outside of the teaching system, prompted by the trainer during the user's daily activities.

In one embodiment, the system performs an optional baseline Pre-assessment of the user's verbal performance once before the first-time play of every song; and Post-assessment occurs after every completion of all of that song's game levels. In one embodiment, this feature is used only by a professional trainer and is enabled by the trainer. If a parent is assisting the user, this feature is typically not used. Game performance data, based on “Yes/No” answers, and all game usage linked to time-stamped actions, are uploaded in real time to an online database. Based on this database, reports for each user are made available to their trainers using easy-to-interpret graphs (e.g. line, bar, pie, etc.) for continued monitoring of outcomes that will support individualized user's progress and program planning, as well as leaderboard information that shows the user's comparison with other users of the system displayed as anonymous metadata. In addition, the data is displayed in a screen location visible to both the trainer and the user in a form that includes icons representing: a) each target word spoken to fill-in the blank, b) each target word spoken and learned by using in a semantic condition, c) each song completed, d) highest game level completed and e) duration spent playing with corresponding timestamps, which in an embodiment uses the outline of the word image and/or song image and fills it step-by-step with color as the user completes the game levels.

Components of the system enhance the user's and trainer's engagement, joint attention between the trainer and user, maintenance, generalization, socialization, and spontaneous use of expressive language. Features include, for example, many songs with 180 or more vocabulary words, individualized curriculum progression based on the user's performance, remote video monitoring and feedback for both parent training efficacy and user' performance, record-playback voice system, automated voice analysis and user feedback system, platform to create user-generated songs, computer generated animation avatar for singing and speaking with automated mouth synchronization, computer generated spoken and sung words from text, community-building platform with peer-to-peer support and song sharing.

The web-based system includes a registration and credit card payment portal for new users, a login portal for returning users, game engine with songs/words, administrative dashboard and controls, HIPAA and FERPA security compliance including data encryption, user access to new songs and system upgrades, embedded pre-post assessment of verbal learning, data and progress reports, trainer and user's account page, and menu settings for controlling game play.

The system is cloud based, and/or web based, and will operate on any internet-connected device, with a preference in an embodiment toward tablet size and portability. The online system includes interactive game engine, user database information, activities, progress reporting, confidentiality, an online platform for sharing songs, song contests, community sing-alongs, joint song creation between families, and a platform for creation, uploading and sharing of music videos based on user-generated songs, and the like.

### BRIEF DESCRIPTION OF THE DRAWINGS

FIG. 1 is a flow diagram illustrating the initial operation of the system in an embodiment.

FIG. 2 illustrates the operation of the system in an embodiment where the user has successfully passed the steps of FIG. 1.

FIG. 3 is a flow diagram illustrating the operation of the system in an embodiment where the user has successfully passed the steps of FIG. 2.

FIG. 4 is a flow diagram illustrating the operation of an embodiment of the system when the user has completed the steps of FIG. 3.

FIG. 5 is a flow diagram illustrating the operation of an embodiment of the system when the user has completed the steps of FIG. 4.

FIG. 6A illustrates a single song remix in an embodiment of the system.

FIG. 6B illustrates a multiple song remix in an embodiment of the system.

FIG. 7 illustrates a Mad Songs in an embodiment of the system.

FIG. 8 illustrates user added words in an embodiment of the system.

FIG. 9 is a flow diagram illustrating user generated songs in an embodiment.

FIG. 10 is a flow diagram illustrating the Progressive Vocabulary Learning System (PVLS) in an embodiment of the system.

FIG. 11 illustrates an example computer environment in an embodiment of the system.

### DETAILED DESCRIPTION OF THE SYSTEM

The system provides a language learning system that is applicable to any user but may have particular value for “at risk” children and children with ASD severity levels 2 and 3 (DSM-5). Such children respond better to music-based speech-language training than non-musical speech-language training, but to date there is little or no availability of this type of training. The system may also be used by users learning a second language or seeking to improve speaking skills. The examples described herein refer to English words and language, but the system could be used with any language.

In an embodiment, the system is a web-based speech-language training game accessible on any internet connected device or suitable assistive technology. The system utilizes music therapy known as Developmental Speech-Language Training through Music (DSLM) that recognizes that children with speech delays/disorders perceive and express musical patterns and learn to sing songs before speaking. Game design and mechanics are also employed to increase learning outcomes for children and trainers.

The music-based training (DSLM) distinguishes the system from other speech-language development products, demonstrating greater neuroplasticity and a higher response rate with the population of children with ASD Levels 2 and 3, for example. The system implements parent-mediated and team training that offers more exposure for the children to training and naturalistic settings than with only professionals (teachers or clinicians), with quicker and more lasting outcomes.

The system utilizes joint media engagement using interactive video gameplay that can increase outcomes of children's receptive and expressive language, maintenance, generalization, and socialization. The system uses interactive, engaging videos and Game Based Learning with, for example, rewards, badges and leaderboards embedded into the system or externally accessed as auxiliary support, to maximize usability and feasibility, and motivate, prepare and maintain fidelity of implementation for trainers to productively administer the system to the users and to serve as advocates and peer-to-peer trainers to other potential users of the system.

In an embodiment the system allows user-generated songs to be created and used as part of the training. This will offer all families of participating parents, children, and other users, and in particular those who may experience geographic and social isolation, the possibility of greater social support with other families facing similar challenges. In addition to the creation and usage of user-generated songs as part of the training, features include, for example, an online platform for sharing songs, song contests, community sing-alongs, joint song creation between families, and a platform for creation, uploading and sharing of music videos based on user-generated songs.

The system begins in a first stage with songs that include musical accompaniment. It has been found that this is an easier way for users to learn language. The system then removes the accompaniment but continues the singing in a second stage. In a third stage, the system transitions to fill-in the missing blank word of the song lyrics when sung. In a fourth stage, the user fills in the missing blank word of the lyric while listening to just spoken words, and finally in a fifth stage to responding to questions to evoke a response of speaking the target word, so that the user can move from singing to conversation in a natural and guided manner.

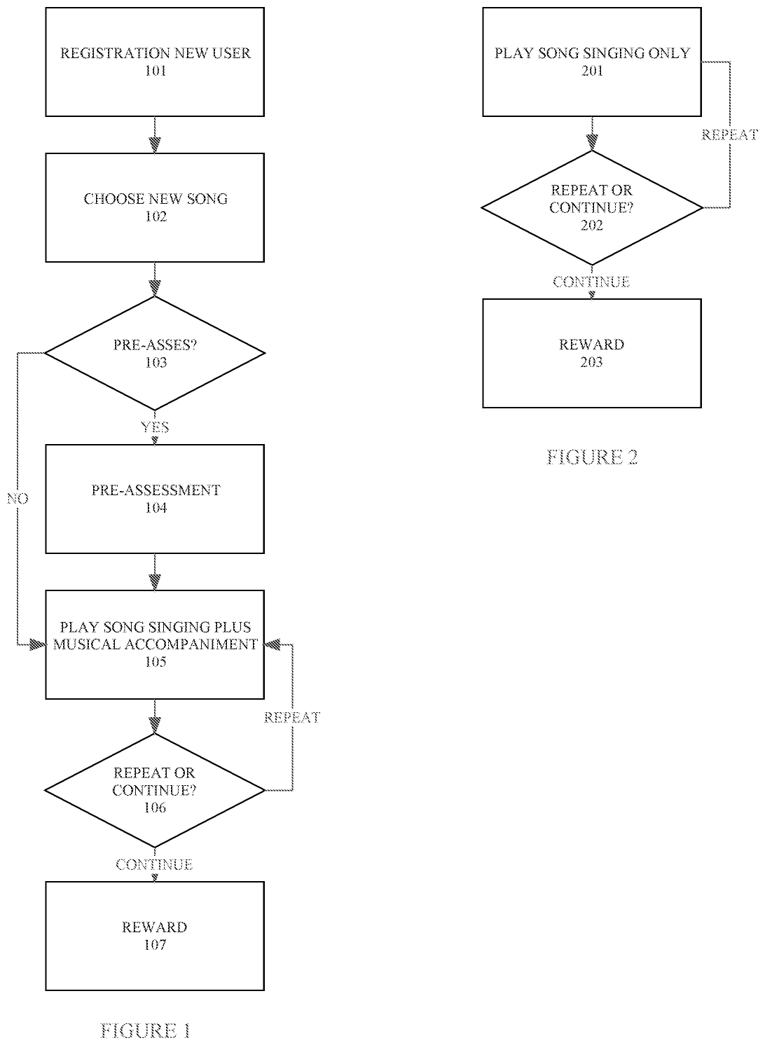

FIG. 1 is a flow diagram illustrating the initial operation of the system in an embodiment. At step 101 a new user is registered into the system. This step assumes that the user qualifies to use the system and a qualification process (not shown) may be implemented to determine if a user is qualified.

At any time, an available Train-the-Trainer interactive audiovisual module may be accessed so the user and/or trainer can learn the basic operations of the system. The Train-the-Trainer materials, including interactive audiovisual modules, video demos, FAQs, forums, chats and online support, are accessible throughout the user interface at every step of the system

The user then proceeds to step 102 and chooses any song available to that user in the system's Song Library. The song includes, in an embodiment, six target words for the user to learn to use effectively. In one embodiment, the target words are found at the end of a line from the song. This has been found to be effective, where all target words are found in the same place, making the user more comfortable and providing an additional way to focus on the target words. In one embodiment, the target words may be distributed differently in the lines of the songs.

At decision block 103 it is determined if it is desired to perform a Pre-Assessment of the user's verbal level. This assessment is optional. If chosen, in step 104, the user (trainer) performs a Pre Assessment of the child's verbal level with the six target vocabulary words in the song, asking a relevant question (e.g., “What is this?”) while showing a photo representing the word. The user selects the appropriate scoring button for the child's verbal response, which in this embodiment are: a) No response; b) Incorrect; c) Approximation (understandable, but incorrectly pronounced); d) Correct. In one embodiment, the system is used in connection with a trainer. In one embodiment, the system is self-directed, with the user interacting with the system alone.

After the Pre-assessment at step 104, or if the Pre-assessment was not chosen at decision block 103, the system proceeds to the first stage of the system, the use of singing with musical accompaniment to introduce the vocabulary words. A song is played with singing plus musical accompaniment (e.g., a guitar) at step 105, with an onscreen singer inviting the user (trainer, child, and/or other user) to sing along. It has been found the singing plus the accompanying instrument is an easier way for the user to engage with a new song for the first time. The song may be only a few lines long in one embodiment of the system. In an embodiment, each song in the system consists of six lines of lyrics, with a target vocabulary word at the end of each lyric line, totaling six words.

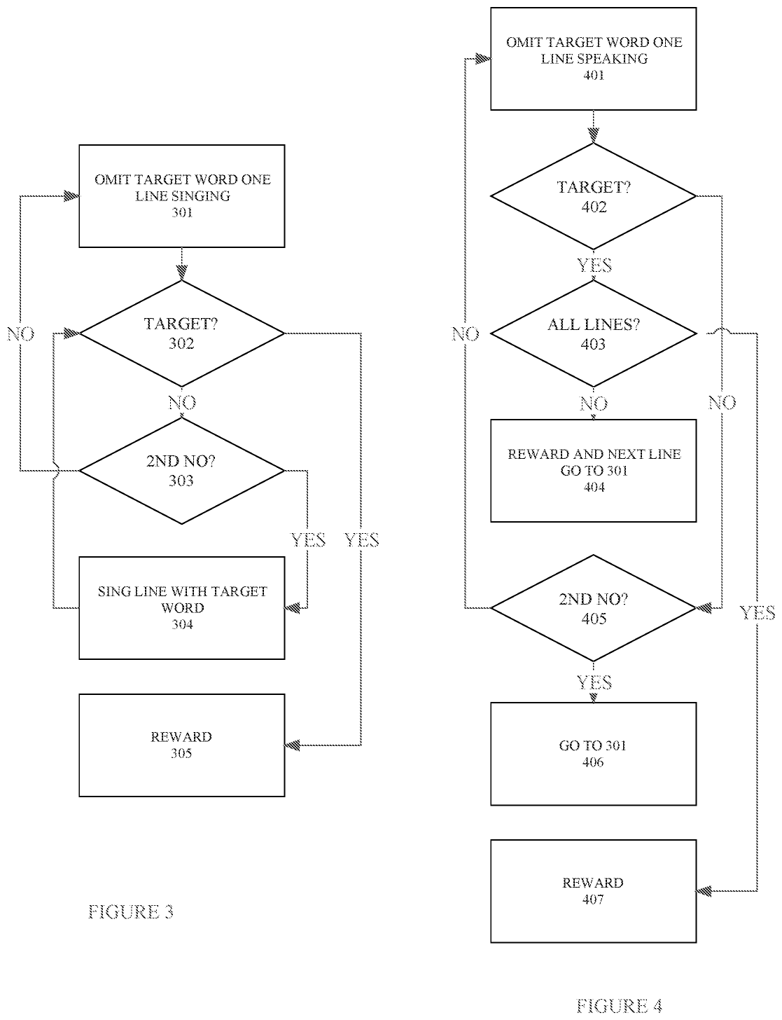

At decision block 106 the user chooses and selects the button to either repeat step 105, listening again to the song with musical accompaniment, or continue to the next stage as described in FIG. 2. In one embodiment, the system provides a reward at step 107. The reward in step 107 may be a cut scene, a badge, a rating, or some audiovisual and/or verbal reward provided to the user only after the user's decision to continue and not repeat that step, or following a successful verbal response from the user. After the reward in step 107, the system proceeds to step 201 in FIG. 2.

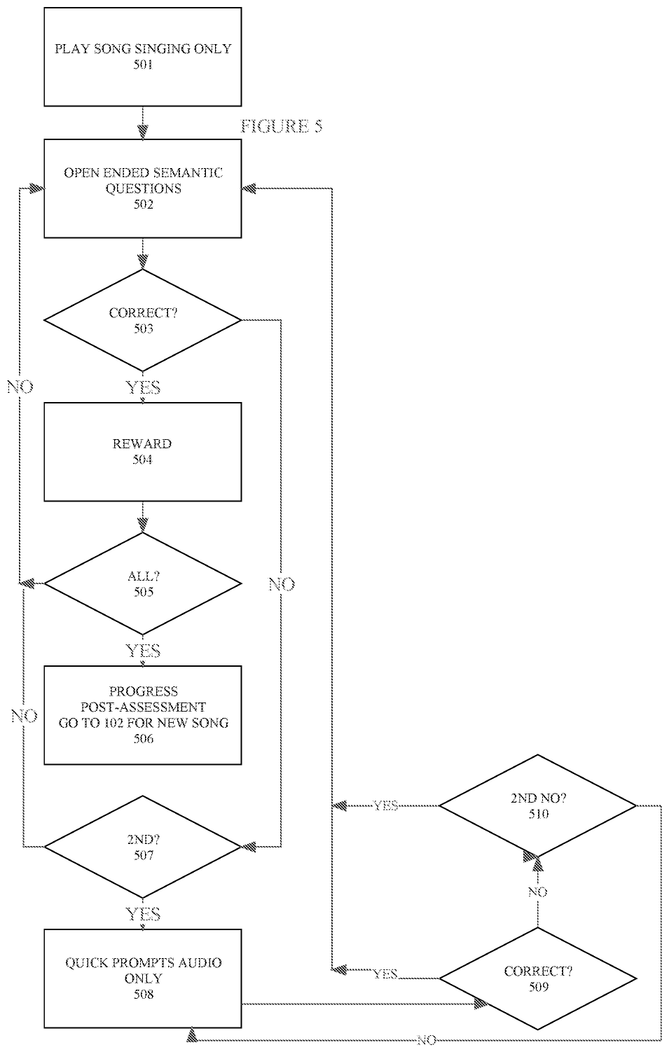

FIG. 2 illustrates the operation of the system in an embodiment of a second stage, where the user has successfully passed the steps of the first stage of FIG. 1. At step 201 the user is presented with a song that has singing only, with no musical accompaniment. This is part of a transition from music to speech. At decision block 202 the user chooses to either repeat step 201, listening again to the song with musical accompaniment, or continue to the next stage as described in FIG. 3. If the user chooses to continue at decision block 202, the system proceeds to step 203 and provides a reward to the user. After the reward in step 203, the system proceeds to FIG. 3.

In the first and second stages, the user is not asked to do anything but listen and get comfortable with the song. In an embodiment where a trainer is used, the trainer will sing along with the song, as a model for the user to hear the desired outcome of singing and speaking. A more active approach for the user begins in the third stage of the system.

FIG. 3 is a flow diagram illustrating the operation of an embodiment of a third stage of the system when the user has completed the steps of FIG. 2. At step 301 the system sings one line of the previously presented song, but with the target last word of that line of the song omitted. The goal is for the user to provide the missing word.

At decision block 302 it is determined if the user has provided, spoken, or sung, the target word. If not, the system proceeds to decision block 303 to determine if this is the second unsuccessful attempt to provide the target word. In one embodiment, the system gives two chances for a correct answer of the target word. If it is not the second unsuccessful attempt at block 303, the system returns to step 301 and sings the line again with the target word omitted.

If the unsuccessful attempt is in fact a second attempt, the system proceeds to step 304 and sings the entire single line with target word and returns to decision block 302. If the user provides the target word at decision block 302, the system proceeds to step 305 and provides a reward to the user. The user and/or trainer can exit this stage by selecting “YES” at step 302 and the system proceeds, or the user can manually select another level to skip to, from inside a level menu for that song, or the user selects Exit to return to the song menu in step 103 to select a new song or discontinue the game play

FIG. 4 is a flow diagram illustrating the operation of an embodiment of a fourth stage of the system when the user has completed the steps of FIG. 3. At step 401 the system speaks the one line from FIG. 3 and omits the target word. At decision block 402 it is determined whether the user has successfully spoken that omitted target word. If so, the system proceeds to decision block 403 to determine if all of the lines (and corresponding target words) have been completed. In one embodiment, there are six lines in a song and a target word in each line. If all lines have been completed, the system provides a reward at step 407. If all lines have not been completed at step 403, the system provides a reward at step 404 and sends the user to the next line at step 301 of FIG. 3.

If the user has not spoken the omitted target word at step 402, the system proceeds to decision block 405 to determine if this is the second unsuccessful attempt. If not, the system returns to step 401 and repeats the spoken line, omitting the target word. If it is the second unsuccessful attempt, at step 406 the system repeats the line and returns the user to step 301 to start again.

FIG. 5 is a flow diagram illustrating the operation of an embodiment of a fifth stage of the system when the user has completed the steps of FIG. 4. At step 501 the system plays the song, singing only, in one embodiment. At step 502 the system presents open ended semantic questions to the user. In one embodiment, the system also includes a photo on the display that is associated with the target word. The answer to the open ended question is the target word. At decision block 503 it is determined if the user has answered the question correctly. If so, the system proceeds to step 504 and rewards the user.

At decision block 505 it is determined if all of the questions have been answered by the user. If so, the system presents an optional progress post assessment at step 506 (such as in the format as the pre assessment in step 104) and returns the user to step 102 for a new song to learn. It should be noted that if a Pre-assessment was not selected at decision block 103, then there is no post assessment at step 506. If the user has not answered all the questions at step 505, the system returns to step 502 and provides open ended semantic questions again for the next target word of the song.

If the user has not answered correctly at 503, the system moves to decision block 507 to determine if this is the second unsuccessful attempt. If not, the system returns to step 502. If so, the system proceeds to step 508 and presents quick prompts with audio only, no singing. In one embodiment, the quick prompt consists of a spoken question with two choices, one correct and one incorrect (e.g., “foot” or “hand”). The order of the two words is randomized so that the user doesn't rely on the correct answer always being in the same order.

After presenting the quick prompt at step 508, the system checks at decision block 509 if the user has answered the question correctly. If so, the system proceeds to step 502 and presents a new open-ended question. If not, the system proceeds to decision block 510 to determine if it is the second time the user has not answered the question correctly. If not, the system returns to step 508. If it is the second no, the system returns to step 502 to present open ended semantic question for the next target word in the song. However, the user's score will reflect that no correct answer was given for that target word at this stage.

A menu feature called “Child Mode” in this embodiment allows the user to toggle off or on the “Yes” and “No” response buttons, and if turned off will replace those buttons with a “Next” button. The “Next” button functions the same as the “Yes” button to go to the next level of the game but does not collect any response data for that level. Default setting is “Child Mode” off and is appropriate for clinical and/or educational purposes to support the child's learning with a professional or informal adult trainer responding with “Yes” or “No” button selections

A menu feature called “Rewards” in this embodiment allows the user to toggle off or on the Rewards sequences, which in one embodiment may include the onscreen singers' face and voice giving an affirmation (e.g., “Yeah!”, “Good job!”, “Well done!”, etc.), a short entertaining animation sequence (e.g., flower blooming, fireworks, mouse jumping up and down on a mushroom, etc.) and a pleasant music jingle (e.g., harp, bells, etc.). If “Rewards” is turned off, then the next level of the game begins immediately after completion of the previous level. Default setting is “Rewards” on.

A menu feature called “Skip” in this embodiment allows the user to skip forward through the levels without needing to first play the levels completely or respond with a “Yes” button action. The default “Skip” setting allows the user to skip forward to a new level after activating a “No” button four times in a row. The user can skip backwards to game levels already completed but will not be allowed to skip forward to a new game level that has not yet been completed. For a registered professional trainer (not parent) without a child or other user playing the game, the “Skip” feature is available at all points in the system.

A menu feature called “Playback Speed” in this embodiment allows the user to alter the speed of the video and audio play. Settings include Normal (100%), Slow (85%) and Slowest (65%). This may support a user who needs more than normal time to absorb and learn the songs and words.

A menu feature called “Display User's Name” in this embodiment allows the user to toggle on or off the display of the user's name that is playing the system. The default setting is on, displaying the user's name.

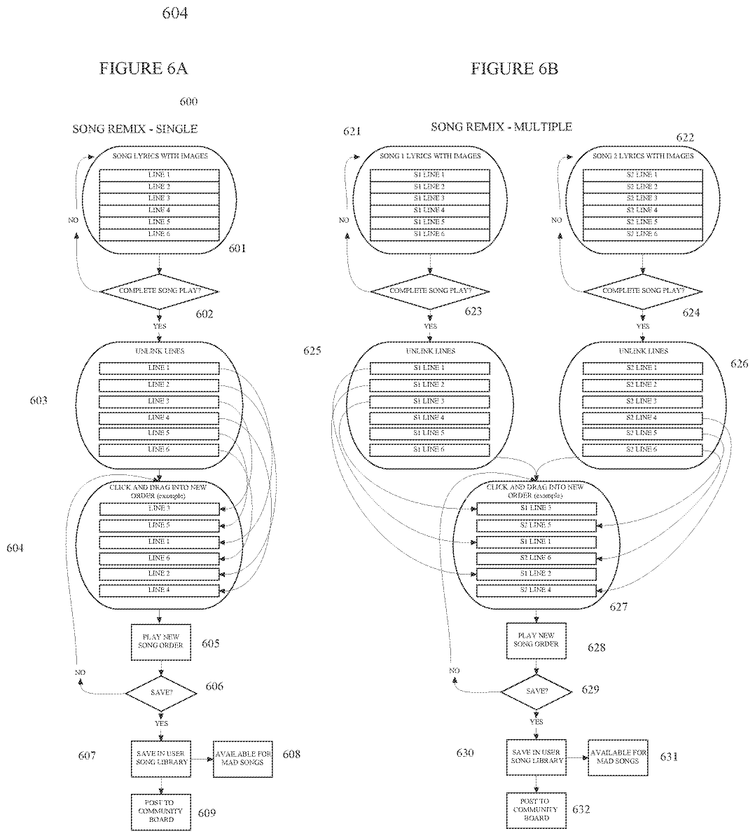

Once a user has completed all the levels of the system for that specific song, then those six lyric lines become available in a Remix platform for the user to click and drag into any order the user would like to listen and watch, named the “Song Remix” in an embodiment, including the audio (singing voice) and video (onscreen singer's face singing the lyrics, image associated with the target vocabulary word). Every time the user completes all levels of another song, this song is added to the Remix platform, adding to the total lyric lines available for another Song Remix. The user can choose to save each Song Remix for later play, and for sharing with other users on the system community platform. Examples are shown in FIGS. 6A and 6B.

Referring to FIG. 6A, at step 601 the user is presented with a song in a default or original mode. At decision block 602 it is determined if all six lines have been completed. If not, the system returns to step 601. If so, the system proceeds to step 603 and the lines are “unlinked” and presented to the user on a display, where they can be re-ordered by the user. At step 603 the user can click and drag the lines into a new order.

At step 605 the song is played back in the new order. At decision block 606 it is determined if the user wants to save the new re-ordered version of the song. If not, the system returns to step 604. If so, the system saves the re-ordered song in the system library at step 607. The song then becomes available for the “Mad Songs” function at step 608 and may be optionally posted to a community board at step 609.

Referring now to FIG. 6B, it describes a song remix from multiple songs 621 and 622. It is determined at decision blocks 623 and 624, respectively, if the user has completed songs 621 and 622. If not, the system returns to the song. If so, the system proceeds to steps 625 and 626 and unlinks the songs. At step 627 the user can drag the lines from either song into a new song using lines from either song in any order.

At step 628 the user plays the new song order. At decision block 629 it is determined if the user wants to save the new song order. If not, the system returns to step 627. If so, the system saves the song in the user library at step 630. The user may make the song available for Mad Songs at step 631 and/or post it to the community at step 632.

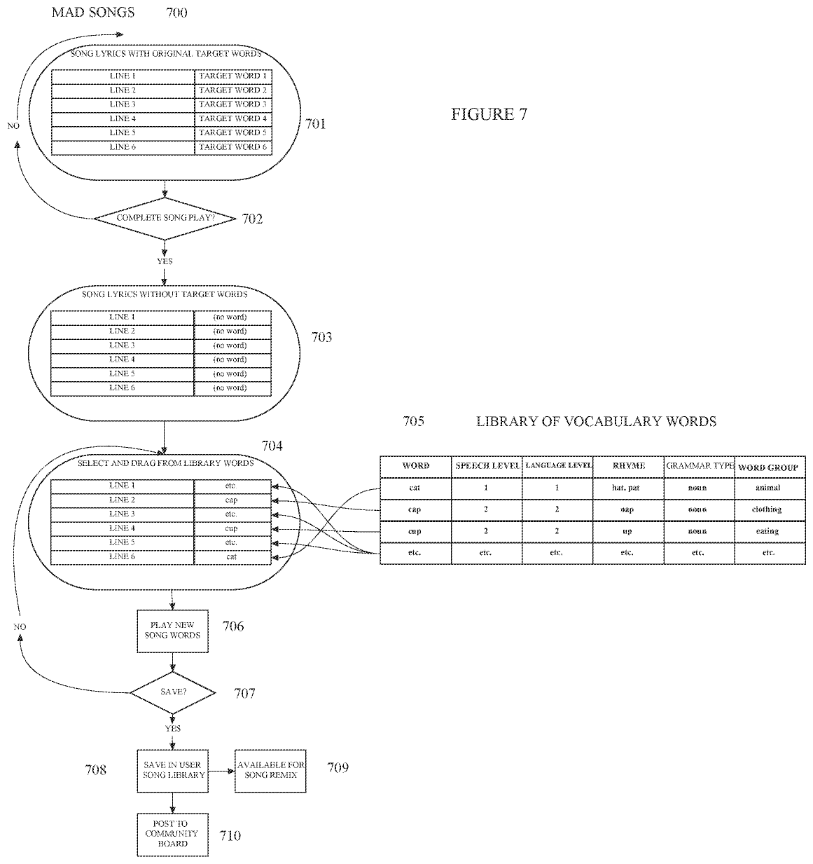

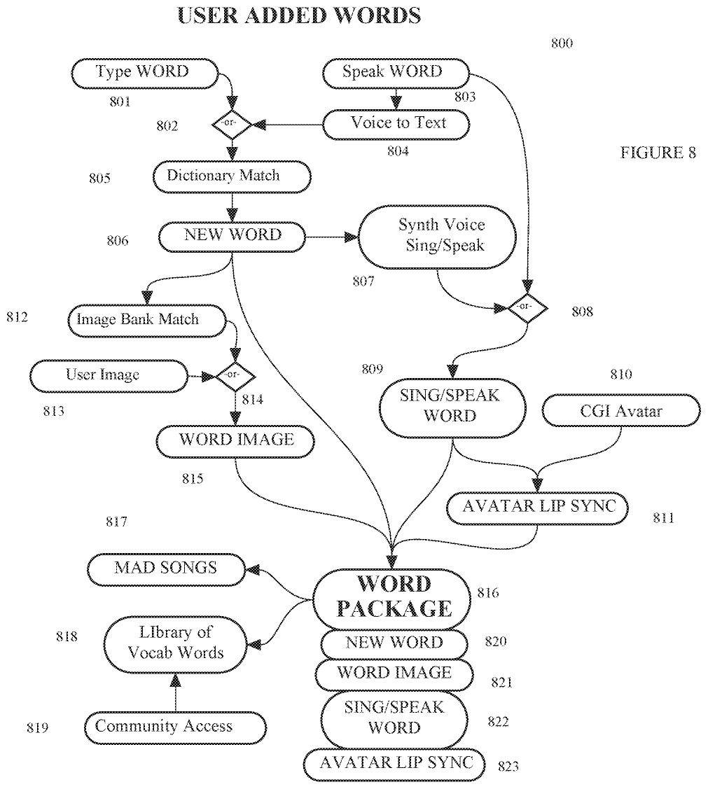

In an embodiment, a feature named “Mad Songs” or “Mad Lyrics” as shown by example 700 in FIG. 7, includes an in-system Library of Vocabulary Words 705 linked to corresponding representational images (photos, drawings, animation) of each word and video clips of a person or character, live or animated, singing and/or saying the word.

At step 701 the user goes through song lyrics with the original target words. At decision block 702 it is determined if the user has completed the song. If not, the system returns to step 701. If so, the system proceeds to step 703 and presents the song lyrics without the target words as a phrase with the target word missing and musical template with the target word missing.

At step 704 the user can select new target words from library 705. The user previews words, then selects a word and/or word photo image by clicking and dragging to the fill-in-the-blank spot of the missing word in a song Lyric Line, commonly being the last word or optionally in some other position in the Lyric Line. The selected sung word fits the musical melody automatically, as the melodic compositions and selected word are in the same fundamental musical key, resolving the melody line harmoniously. The Lyric Line with the new word can be either:

1. Maintained in the original song's order, or

2. Mixed into a new song Lyric Line order through the same mechanism of Song Remix described above.

At step 706 the user plays the song with the new words. At decision block 707 it is determined if the user wants to save the new version. If not, the system returns to step 704. If so, the system saves the new song in the user song library at step 708. The new song may be made available for song remix at step 709 and/or shared with the community at step 710.

Categorizing Target Words

Words used in the songs are categorized and tagged with associated Progressive Vocabulary Learning System (“PVLS”) rating, Rhyme, Grammar Type, Word Groups, and Phonemes:

1. PVLS ratings of a) speech/articulation, and b) language/usage. When the user successfully completes a song that has a given rating for its word PVLS, the user can access songs and words that have a higher PVLS rating. The song word PVLS rating is calculated based on the sum of the individual PVLS ratings of each word in each song, for both a) speech/articulation, and b) language/usage.

2. Rhyme similarities. Words can be accessed by linking to other words that Rhyme with the last word in one of the previous lines in the song lyrics.

3. Grammar Type. Words are categorized by Grammar Type (e.g. noun, verb, adjective, adverb), so that each song lyric can be completed with the grammatically appropriate word type.

4. Word Group Themes. Words are categorized into Word Groups based on themes (e.g. sports, animals, transportation, food, body parts, clothing, hygiene, family members, etc.).

Word Groups are added to the library of vocabulary words for user access by:

a. User successfully completing Song plays, thus demonstrating learning to sing and speak those target vocabulary words, or

b. Performing other gameplay actions that are linked to this reward, or

c. In-system subscription upgrade to access additional Word Groups.

5. Phonemes (Not shown in FIG. 7). Phonemes are any of the perceptually distinct units of sound that distinguish one word from another, for example p, b, d, and t in the English words pad, pat, bad, and bat. There are 44 distinct phonemes in the English language. In an embodiment, vocabulary words are categorized and tagged by all the Phonemes that are components of that vocabulary word. The user may search and find all words in the system that have one or more phonemes, and the word's associated song, which may be played to help a user who needs speech articulation training for specific phonemes.

FIG. 10 is a flow diagram illustrating the operation of the system using the PVLS rating. At step 1001 the user selects a vocabulary word. In an example, the user selects the first one of six vocabulary words. There are two paths that are followed after this. The first path is for the Speech Articulation Scoring Value of the word and the second path is the Language Usage Scoring Value of the word.

The Speech Articulation (SA) scoring value 1002 is on a scale of one to five in one embodiment, with one being the easiest and five being the most difficult. At step 1004 the word is scored for SA on a manual or by Artificial Intelligence or machine learning. At step 1008 the SA scores of all 6 words per song are summed.

After the songs are scored, they are ranked from easiest to most difficult based on their summed SA scores at step 1010. The PVLS system takes a user from easiest to hardest at controlled pace. When a user completes a song at level X at step 1012, songs at the next level X+1 become available to the user at step 1014.

In one embodiment a trainer can override the PVLS system at step 1016 and skip levels to play specific words, songs or vocabulary levels, or select to play all songs at step 1018.

In the Language Usage (LU) path the LU score 1003 is given a scale from one to five, with one being easiest and five being most difficult. The LU score for the current word is assigned (again manually or via AI) at step 1005. The LU scores are determined for all words of a song at step 1007. The LU total per song is calculated at step 1009.

At step 1011 the songs are ranked from easiest to most difficult based on the LU score. A user can move through the songs at step 1013 and when the user completes a song at a particular level X, the system makes songs at level X+1 available at step 1015.

A trainer can override PVLS at step 1017 and open all songs to play at step 1019.

User Added Words

FIG. 8 is a flow diagram illustrating a feature 800 called “User Added Words” in an embodiment. Using this feature, the user may augment the in-system Library of Vocabulary Words with additional vocabulary words that are typed or spoken into the system by the user.

The system recognizes the added typed 801 or 802 spoken word 803 converted by voice to Text 804 and matches it to an English language dictionary database 805 of words (e.g., WordNet, or DataMuse) and designates a New Word 806, then passed through a child-friendly word filter Dictionary/Database (not shown in FIG. 8) to block inappropriate user generated words. The system searches in an image bank 812 (e.g., Getty Images) and associates the new word to a corresponding image, which is then transferred into the system and linked to the new word 815. Alternatively, 814, the user may upload an image of their choice 813 to correspond with the new word. 815. In an embodiment, this could be the name of a person or pet, with corresponding image.

The system converts the new word 806 into a synthesized voice 807 that sings and/or speaks the word. The synthesized voice, or 808 alternatively the user's own recording of the spoken word 803, is used to generate synchronized mouth movement 811 of a computer generated image (CGI) avatar face 810 so that it appears to be the speaker or singer of the synthesized voice or user's own voice. In one embodiment, the synthesized voice selection includes various parameters to choose from (e.g., age, gender, accent, and the like). In one embodiment, the synthesized voice may also be cloned from the input vocal pattern of any user (e.g., trainer's voice, parent's voice, and the like) 803, that serves to generate the synthesized voice pattern for the entire song. Having a familiar voice communicate with the user may improve performance.

The new word is packaged 816, and associated elements of corresponding image 821, synthesized voice or user's own voice 822, and CGI avatar 823 mouthing the new word 820, and made accessible to the user for use in the Mad Songs feature 817. The system may collect the new words and associated elements to augment the in-system Library of Vocabulary Words 818, making these available to other users in the community 819.

User Generated Songs

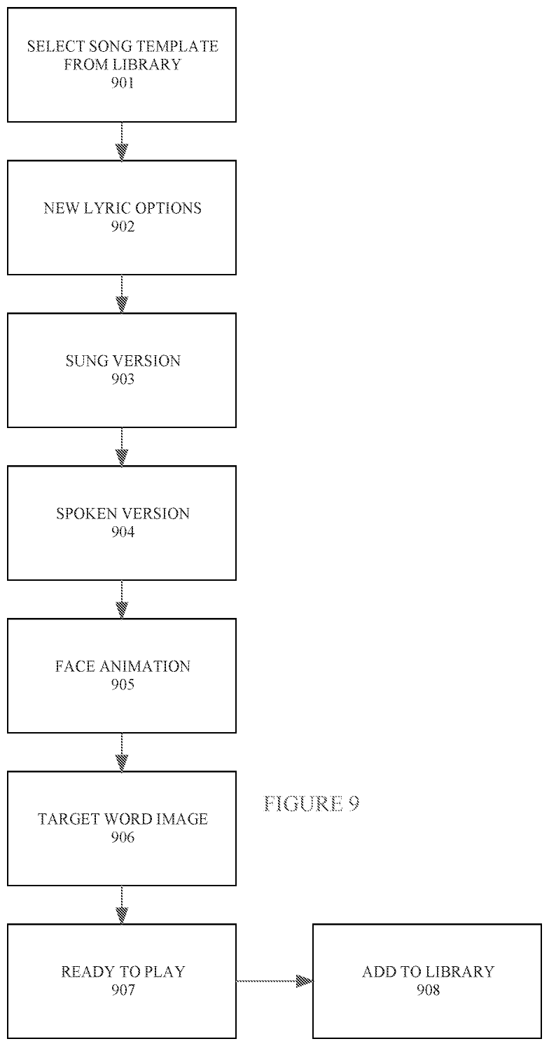

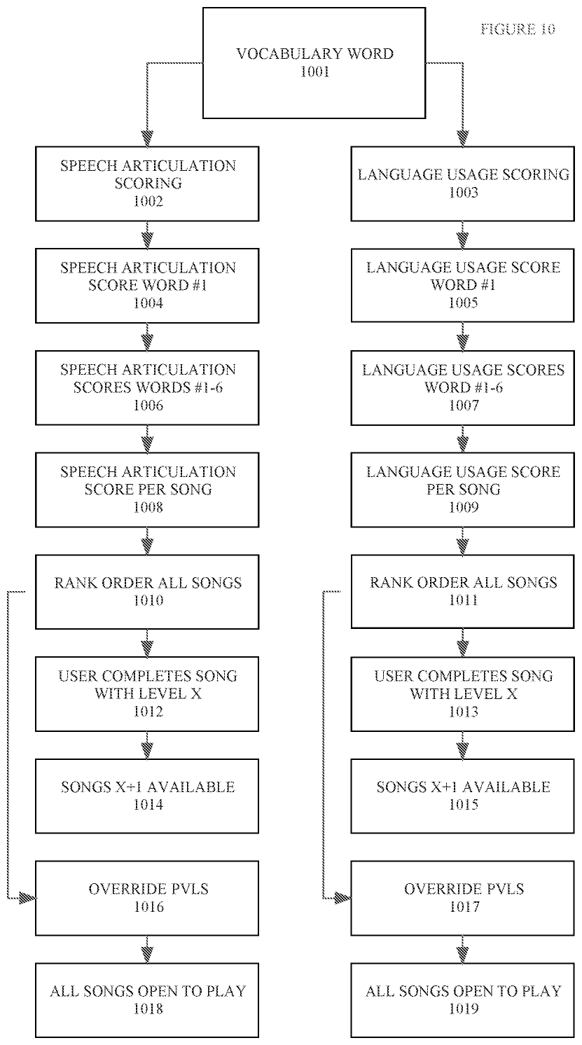

In one embodiment, a user may generate their own custom songs using a song template, also referred to as a phrasal template and/or musical template. FIG. 9 is a flow diagram illustrating custom song generation in an embodiment. At step 901 the user can select a song template from a song library. The templates include a plurality of melodies that can easily be matched with lyrics and target words to provide customized experience. In one embodiment, the user can modify the melody if desired. The user can select different keys of the melody, may change the melody itself, and/or may choose the instrumentation that accompanies the song when sung.

At step 902 the user can select the lyrics that will go with the song. In one embodiment the template may include existing lyrics. In one embodiment, the lyrics are blank and can be written by the user or may be auto-generated by the system. The new words to be used in the lyrics may come from a menu driven dictionary, user generated text, user voice to text, and/or word image click and drag.

At step 903 the sung version is generated. The system voice will sing the entire song with instruments, sing the song alone with just voice and no accompaniment, and sing with voice alone, leaving a fill-in-the blank location for the target word. At step 904 the spoken version is prepared. This may be via text to speech or by the user speaking, or a cloned voice as noted above. The words are spoken leaving a fill in the blank region for the target word, and an open ended semantic question is prepared whose answer is the target word.

At step 905 the singer/speaker animation is added to the new song. At this stage, the user can select a number of options for the image avatar, including gender, age, ethnicity, and the like, as well as custom facial features and clothing (including hair style and color, skin tone, glasses, etc.).

At step 906 an image to be associated with the word is chosen. This may be from a stock photo database, an uploaded user image, and/or an image click and drag operation. The system may display top search results for the user to select which image to display with the Target Word. At step 907 the customized song is ready for use and may be added to the library at step 908. The song will be analyzed and will be given a PVLS rating so that the song will be inserted into the system at an appropriate location for the user. The new song may be shared with the community as desired.

Community Sharing

Each user has the option of keeping their personal song library private. In one embodiment, when a user decides to make one or more personal library songs public, the song has two public permission levels. For registered users of the community, all stages from one through five are available to the users. In an embodiment where there is a public external platform, where potential users can try out the platform, only stage one (e.g., singing with musical accompaniment) is playable.

When a song is shared to the community, it becomes searchable by new and original title, new words, name of user, date posted, and the like. In one embodiment, the system filters searches so that only songs at the PVLS rating of the searching user are presented in the search results. The system can also provide metadata about the song including number of song plays, number of unique users, popular vote, and the like.

The system can also moderate song contests periodically, during holidays, based on themes, and the like. The system can award prizes for contest winners, popular songs, community involvement, and the like.

### Other Embodiments

In an embodiment, a community platform allows users to share their songs generated by Song Remix or Mad Songs, or any other user generated songs created within the system, with an online user that has access to this platform. This platform may reside as an in-system platform or with third party social media platforms, e.g. Facebook.

In an embodiment, the community platform allows users to submit their songs for contests that can be voted upon by the system management team, system users and/or general public.

In an embodiment, the community platform allows users to communicate with each other in a peer-to-peer support group, participate in community sing-alongs and joint song creation between families by utilizing the system's capacity to create user-generated songs.

In an embodiment, an artificial intelligence system (PVLS) tracks each user's progress by marking the level of difficulty of the target words and songs that the user has completed successfully in the system. The level of difficulty of each word is determined by a score of 1—easiest, to 5—most difficult, established for two parameters: a) speech and articulation/pronunciation, and b) language usage and concept. The level of difficulty of each song is determined by the cumulative scores of all target words of the song for the two parameters of speech and language described above. When the user has successfully completed a certain difficulty level score for target words and/or song, then songs with the next higher level of difficulty will be made accessible to the user, thus building upon the user's speech-language skills step-by-step as they progress through the system.

In an embodiment, a progress meter reward system supports the user's learning experience by exhibiting silhouetted or outlined graphic images that represent each song the user plays. As the user completes the song levels, the graphic image for that song fills in with color and/or shading to illustrate the level of completion of each song. When the user completes all song levels and the song's graphic image is completely filled, an audio-visual animation reward plays, and then more song icons appear for the user to play more songs, that, in an embodiment, are scored at higher levels of difficulty.

In an embodiment, the reward system also supports the user's learning experience and engagement level by illustrating in a progress meter the duration of time the user is playing the system within a single session, as well as accumulated time for all sessions, so that regardless of the user's performance of word learning, the user receives positive feedback for the time spent on playing the system.

In an embodiment, a video and/or audio only recording and playback system allows the users to record their system sessions so that these sessions may be reviewed at any time by the trainers and users to help reinforce learning outcomes. These sessions are labeled and accessed by date and song played, and may be used for comparison to show progress over time.

In an embodiment, the voice of the user singing or speaking a target word is recorded by the system and digitally analyzed and compared to: a) a naturally pronounced version of the target word that is recorded and stored in the system's database memory; and b) the user's own voice previously recorded singing or speaking the target word. This analysis reports how close the most recent recording is to the previous recordings of a) and/or b) described above. The system gives feedback on the user's progress over time in a simple graphic form and an audio playback system, to help the user by hearing the difference between their spoken version and a more accurate spoken version, to encourage learning outcomes.

In an embodiment, an online chat room can be accessed by all trainers that have been given consent by the child's parent or legal guardian, to facilitate training, feedback, and any other desired text communication between the professional and informal trainers. The chat room can run synchronously or asynchronously.

In an embodiment, an online calendar allows trainers to schedule system sessions, with notice alerts automatically sent to the trainers by text, email or any other electronic messaging system that may be applicable for this purpose. A feature of this calendar records the actual usage of the system and compares to the scheduled usage, giving a report on how closely the trainer is adhering to the planned schedule. This report produces a colorful graphic reward for high adherence and a friendly, encouraging text reminder for low adherence. A goal setting menu integrates with the online calendar features, and allows trainers to set their own expectations for frequency and duration of system usage, with options for High, Medium, Low or Custom levels of goal setting.

In an embodiment, the onscreen singer/speaker is a computer generated image face (“Avatar”) whose mouth is synchronized to the lyrics/text of the song and spoken words. This Avatar can reflect a variety of ethnic, gender and age types, including non-human or fantasy characters, which can be selected in the system menu. The user's selections may reflect their own ethnicity or preferences, aiming to enhance their engagement with the system.

In an embodiment that utilizes the Avatar as described above, the user may type in their own words to replace the pre-existing song lyrics, which are converted from text to voice and sung and/or spoken by the Avatar.

A train-the-trainers (T3) interactive audio-visual module accompanies the system that, in an embodiment, allows the trainer to simulate playing the system with a voice recording of a user responding correctly or incorrectly to each system level's request for action (e.g., answer “What is this?” on the screen), so the trainer can practice and learn how the system operates in real-time, to prepare for playing the system with a live user who will be a user of the system. Content of the T3 module can be accessed at any time during the system usage (“just-in-time learning”) for review or for introducing more detailed instructions or advanced subject matters, e.g., scenario options for different user types or environmental situations. The interactive system simulation offers the user constructive feedback when the user operates the system incorrectly and then another opportunity to operate correctly, so the user learns by doing and can move forward with ease and confidence to begin or continue training the user. The T3 module is available in multiple languages, which can be selected in the system menu.

In an embodiment, the trainer operates the system with a remote control that is using a second internet-connected device (e.g. a smartphone with a downloaded system app) to control the main device (e.g. tablet, laptop or TV screen) that is presenting the system's audiovisual interface that the user sees and hears. The two devices (e.g. smartphone and tablet) are synchronized by the online system. This allows the user to be undistracted by any control buttons or actions on their system screen that are made by the trainer, and able to focus entirely on the audiovisual elements of the song and gameplay. The trainer's remote control display is simplified to present only the buttons needed at that moment in the system play (e.g., “Yes” or “No”) so that there is minimum distraction for the trainer away from engaging with the main system screen and the user, thus maintaining the essential level of “joint attention” to the system content and user that is recommended for best learning outcomes.

Example Computer Environment

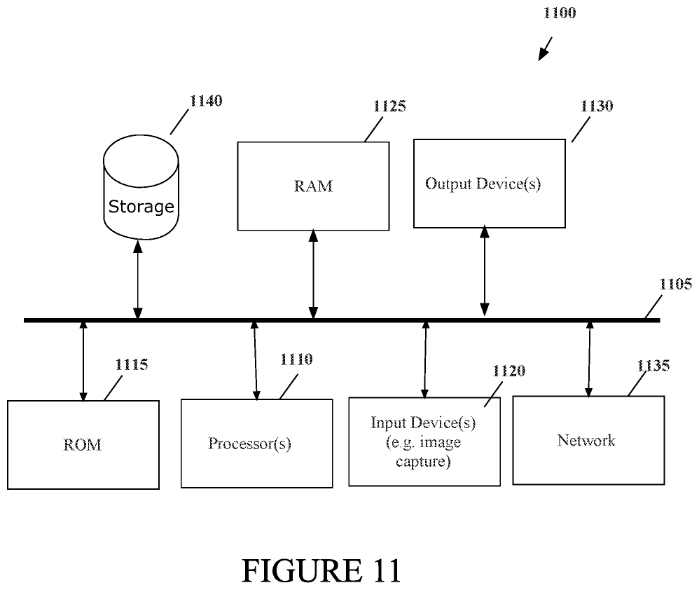

FIG. 11 illustrates an exemplary system 1100 that may implement the system. The electronic system 1100 of some embodiments may be a mobile apparatus. The electronic system includes various types of machine readable media and interfaces. The electronic system includes a bus 1105, processor(s) 1110, read only memory (ROM) 1115, input device(s) 1120, random access memory (RAM) 1125, output device(s) 1130, a network component 1135, and a permanent storage device 1140.

The bus 1105 communicatively connects the internal devices and/or components of the electronic system. For instance, the bus 1105 communicatively connects the processor(s) 1110 with the ROM 1115, the RAM 1125, and the permanent storage 1140. The processor(s) 1110 retrieve instructions from the memory units to execute processes of the invention.

The processor(s) 1110 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 1110, they cause the processor(s) 1110 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 1110. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 1100, define one or more specific machine implementations that execute and perform the operations of the software programs.

The ROM 1115 stores static instructions needed by the processor(s) 1110 and other components of the electronic system. The ROM may store the instructions necessary for the processor(s) 1110 to execute the processes provided by the system. The permanent storage 1140 is a non-volatile memory that stores instructions and data when the electronic system 1100 is on or off. The permanent storage 1140 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 1125 is a volatile read/write memory. The RAM 1125 stores instructions needed by the processor(s) 1110 at runtime, the RAM 1125 may also store the real-time video or still images acquired by the system. The bus 1105 also connects input and output devices 1120 and 1130. The input devices enable the user to communicate information and select commands to the electronic system. The input devices 1120 may be a keypad, audio and/or image capture apparatus, or a touch screen display capable of receiving touch interactions. The output device(s) 1130 display images and/or play audio generated by the electronic system. The output devices may include printers or display devices such as monitors and/or audio outputs.

The bus 1105 also couples the electronic system to a network 1135. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, 4G, 5G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, an improved method of language learning has been described.

### APPENDIX—CITATIONS

Farrell, L., Osenga, T., Hunter, M. (2013). Comparing the Dolch and Fry High Frequency Word Lists, http://www.readsters.com/wp-content/uploads/ComparingDolchAndFryLists.pdf
Fenson, L., Marchman, V., Thal, D. Dale, P., Reznick, J., Bates, E. (2007). The MacArthur-Bates Communicative Development Inventories User's Guide and Technical Manual, Second Edition. Brookes Publishing.
Kaplan, R. S., & Steele, A. L. (2005). An analysis of music therapy program goals and outcomes for clients with diagnoses on the autism spectrum. Journal of music therapy, 42(1), 2-19.
Kim, J., Wigram, T., & Gold, C. (2009). Emotional, motivational, and interpersonal responsiveness of children with autism in improvisational music therapy. Autism, 13(4), 389-409.
Lim, H. (2010), The Effect of “Developmental Speech-Language Training through Music” on Speech Production in Children with Autism Spectrum Disorders. Journal of Music Therapy, 47(1):2-26.
McGonigal, J. (2011), Reality Is Broken: Why Games Make Us Better and How They Can Change the World, Penguin Books; Reprint edition.
Moreno, S., Bialystok, E., Barac, R., Schellenberg, E. G., Cepeda, N. J., & Chau, T. (2011). Short-term music training enhances verbal intelligence and executive function. Psychological Science, 22(11), 1425-1433.
Patel, A. (2011). Why would Musical Training Benefit the Neural Encoding of Speech? The OPERA Hypothesis. Front Psychol. 2: 142. https://www.ncbi.nlm.nih.gov/pmc/articles/PMC3128244/
O'Rourke, E., Haimovitz, K., Ballweber, C., Dweck, C., Popović, Z. (2014), Brain points: a growth mindset incentive structure boosts persistence in an educational game. CHI '14: Proceedings of the SIGCHI Conference on Human Factors in Computing SystemsApril 2014 Pages 3339-3348 https://doi.org/10.1145/2556288.2557157
Strait D., Kraus N. (2011). Can You Hear Me Now? Musical Training Shapes Functional Brain Networks for Selective Auditory Attention and Hearing Speech in Noise. Front Psychol. 2011; 2: 113.
Takeuchi, L & Stevens, R. (2011). The new coviewing: Designing for learning through joint media engagement. New York: The Joan Ganz Cooney Center at Sesame Workshop.

What is claimed is:

1. A method of teaching target words comprising:
in a processing system,
presenting a first stage of the method of singing of a song having at least one of a first plurality of target words in each line, and including musical accompaniment;
presenting a second stage of the method of the singing of the song with no musical accompaniment;
presenting a third stage of the method of the singing of the song with no musical accompaniment and omitting the target word from each line;
requesting a user to complete each line with the omitted target word;
presenting a fourth stage of the method of speaking the song without singing and without musical accompaniment and omitting the target word from each line;
requesting the user to complete each line with the omitted target word;
presenting a fifth stage of the method of asking an open ended semantic question whose answer is one of the first plurality of target words;
requesting the user to answer the question with the one target word.

2. The method of claim 1 further including asking an open ended semantic question for each of the first plurality of target words.

3. The method of claim 2 wherein the user has two chances to identify the target word in the third stage.

4. The method of claim 3 wherein the user has two chances to identify the target word in the fourth stage.

5. The method of claim 4 wherein the user has two chances to identify the target word in the fifth stage.

6. The method of claim 5 wherein the user is given a reward when the correct target word is provided by the user.
